(19) United States
(12) Patent Application Publication
(10) Pub. No.: US 2005/0156473 A1
(43) Pub. Date: Jul. 21, 2005

(54) Polyphase linear motor and its drive method, and stage device, exposure system, and device manufacturing method using the polyphase linear motor

(75) Inventor: Asano Tosiya, Tochigi-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/025,945

(22) Filed: Jan. 3, 2005

(30) Foreign Application Priority Data
Jan. 15, 2004 (JP) 2004-008120

(51) Int. Cl. H02K 41/00; H02K 23/60

(52) U.S. Cl. 310/120

(57) ABSTRACT

Upon initialization of the polyphase linear motor having a mover and a stator, there are a first step of selecting any or all of a plurality of coil phases to supply the selected coil phase(s) with a first constant current so as to drive the mover to a first electromechanical stability point, a second step of supplying a second constant current to the same or different coil phase(s) as or from those selected for supplying the first constant current to drive the mover to a second electromechanical stability point, and a third step of supplying each coil phase with a predetermined current according to the second electromechanical stability point to drive the mover to a predetermined reference point.

### BACKGROUND OF THE INVENTION

1. Field of the Invention

The present invention relates to a polyphase linear motor and its drive method. In particular, it relates to an initialization method used for determining the absolute position of a moving part of a polyphase linear motor when the position of the moving part in relation to a stationary part cannot be determined at power-on or reset.

2. Description of the Related Art

The polyphase linear motor is a moving magnet linear motor having a stationary part or stator and a moving part or mover. The stator includes coil units each consisting of coils of two or more phases and arrayed along the traveling direction of the mover. The mover includes magnets arrayed side by side, with alternating N and S poles, along its traveling direction.

The polyphase linear motor may also be a moving coil linear motor. In this case, the stator includes magnets arrayed along the traveling direction, and the mover includes coil units. In either case, a current to be passed in each phase is a sinusoidal current determined by multiplying the command value set for the linear motor by a rectified value calculated from a trigonometric function according to the phase angle determined by the relative position between the mover and stator.

If the polyphase linear motor is used in a device requiring high-precision positioning, like a moving stage in a semiconductor exposure system, it will be common practice to use a laser interferometer as means for measuring the position of the stage. The laser interferometer is a relative position sensor that cannot measure the absolute position of the stage at power-on or upon resuming after laser shutdown. The rectified value is calculated using the value measured by the laser interferometer. Since the phase angle cannot be determined at power-on or reset, the rectified value cannot be calculated from the trigonometric function, and hence the linear motor cannot be driven. One solution to this problem is disclosed in Japanese patent laid-open application No. 11-316607, in which an ultrasonic sensor is used in conjunction with an absolute position sensor. Further, Japanese patent laid-open application No. 2003-199380 discloses an initialization method for a moving coil polyphase linear motor without using an absolute position sensor. In this initialization method, a constant current is passed through one phase to determine the phase angle of a point on a periodic wave, at which the stage has stopped, as being a uniquely specified point of the initial phase angle (hereinafter called an “electromechanical stability point”). Then, based on the determined phase angle, the stage is driven to a predetermined reference position to determine the absolute position.

As disclosed in Japanese patent laid-open application No. 11-316607, concurrent use of the absolute position sensor makes it possible to determine the relative position between the stator and mover at power-on or reset. However, it requires peripheral circuits for the absolute position sensor, making the structure complicated and increasing its manufacturing costs. On the other hand, in Japanese patent laid-open application No. 2003-199380, the relationship between the position of the stage and the force of the linear motor is represented by a sine wave in the constant current case. Since the sine wave has zero value at phases of 0 and 180 degrees, ideal stop positions are two points, and this makes it difficult to ensure that the initial phase angle can be determined.

### SUMMARY OF THE INVENTION

In one aspect of the present invention, there is provided a drive method of a polyphase linear motor having a mover and a stator, comprising:
a first step of supplying a first constant current to at least any of a plurality of coil phases to drive the mover to a first electromechanical stability point;
a second step of supplying a second constant current to the same or different coil phase(s) as or from that in the first step to move the mover to a second electromechanical stability point; and
a third step of supplying a predetermined current to each coil phase according to the second electromechanical stability point to drive the mover to a predetermined reference position.

As will be described later in connection with preferred embodiments, the first and second electromechanical stability points also include their neighboring points.

By using the present invention, the initial phase angle of the polyphase linear motor can be determined reliably in a short time using an inexpensive mechanism.

It is preferable to have two or more first electromechanical stability points between which the second electromechanical stability point resides.

It is also preferable that the phase of the sum of propulsive forces or thrusts produced by respective coil phases under the application of the second constant current be different from the phase of the sum of thrusts produced by respective coil phases under the application of the first constant current.

It is further preferable to supply a negative or positive constant current in the first step to all the phases of the plurality of coils and, in the second step, to supply at least one of all the coil phases with a constant current with a sign opposite to that supplied in the first step. Thus, since all the coil phases are used, the load on the driver can be reduced. Further, since the sign, plus or minus, of the constant current is changed for at least one phase alone, the above-mentioned effects can be achieved by a simpler current control operation.

The polyphase linear motor preferably includes a plurality of coil units each having the plurality of coil phases so that current will be passed through all the coil units in the first and second steps. This enables initialization of the polyphase linear motor even when the initial position of the mover is beyond calculation.

Further, either the mover or the stator preferably has a magnet part that produces a periodic distribution of magnetic flux along the traveling direction of the mover. The term “periodic distribution of magnetic flux” as used here means a distribution of magnetic flux close to that of a periodic wave, for example, of a sinusoidal or trapezoidal wave imparted in the magnets arrayed with alternating N and S poles along the traveling direction.

More preferably, the polyphase linear motor further includes relative position detecting means for detecting the relative position of the mover and reference position determining means for determining the reference position of the mover, and the drive method further includes a fourth step of detecting the absolute position of the mover using the relative position detecting means based on the reference position determined by the reference position determining means. This makes it possible to detect the absolute position of the mover without using absolute position detecting means, and hence reduces the cost of the initialization mechanism of the polyphase linear motor.

Preferably, the relative position detecting means is a laser interferometer and the reference position determining means is an origin point sensor such as a photosensor. It should be noted that the detection of the position of the mover includes the detection of the position of a stage or the like fixed to the mover.

In another aspect of the present invention, there is provided a polyphase linear motor having a mover and a stator, comprising:
phase angle specifying command generating means for generating a command for specifying the phase angle determined from the relative position between the mover and the stator; and
a driver for selecting any or all of coils based on the command from the phase angle specifying command generating means to supply the selected coil(s) with a first constant current and then to supply a second constant current to the same or different coil(s) as or from those selected for supplying the first constant current. This makes it possible to determine the initial phase angle of the polyphase linear motor reliably in a short time.

In this case, it is preferable that the phase of the sum of thrusts produced by respective coil phases under the application of the second constant current be different from the phase of the sum of thrusts produced by respective coil phases under the application of the first constant current.

In still another aspect of the present invention, there is provided a drive method of a polyphase linear motor having a periodic thrust index, the polyphase linear motor including a plurality of coil units each having a plurality of coil phases. In this drive method, a first constant current is supplied to all of the plurality of coil units, and then a second constant current different from the first constant current is supplied to specify the phase angle determined from the relative position between the mover and the stator.

In this case, it is preferable that the second constant current be made different from the first constant current by changing the combination of current values to be supplied to each coil phase of the coil units.

It is also preferable that a stage device perform initialization using the above-mentioned polyphase linear motor and its drive method to locate the position of a moving stage fixed to the mover. It is further preferable that the stage device be used to locate the position of a substrate or master mask in an exposure system. The exposure system is preferably used in a device manufacturing method for manufacturing devices. In such a case, the stage device can reduce time required to locate the position of the stage as a whole, so that the exposure system can achieve high throughput at low cost, thereby manufacturing devices with high precision at low cost.

### BRIEF DESCRIPTION OF THE DRAWINGS

FIG. 1 is a block diagram of a stage control system according to a first embodiment.

FIG. 2 is a schematic diagram of a stage using a polyphase linear motor.

FIG. 3 is a schematic diagram showing a mover of the polyphase linear motor.

FIG. 4 is a schematic diagram showing coil units of the polyphase linear motor.

FIG. 5 is a schematic diagram showing a state in which a coil selector has selected coil A2.

FIG. 6 is a schematic diagram showing a state in which the coil selector has selected all coils.

FIG. 7 is a graph showing linear motor thrust index versus stage position when a constant current is passed through each phase in a three-phase linear motor.

FIG. 8 is a graph showing linear motor thrust index versus stage position at fist step.

FIG. 9 is a graph showing linear motor thrust index versus stage position at first and second steps.

FIG. 10 is a flowchart of initialization in the first embodiment.

FIG. 11 is a schematic diagram of an exposure system of the first embodiment.

FIG. 12 is a flowchart showing a device manufacturing method of the first embodiment.

FIG. 13 is a flowchart showing a wafer process.

### DETAILED DESCRIPTION OF THE INVENTION

### First Embodiment

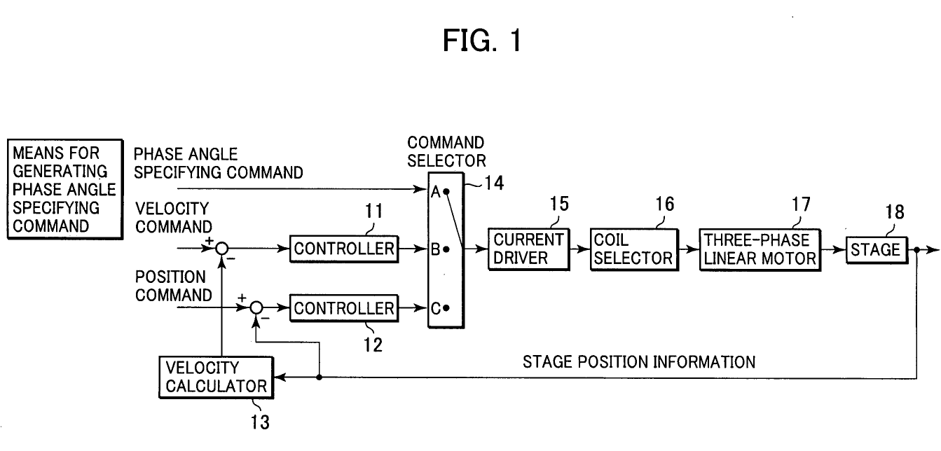

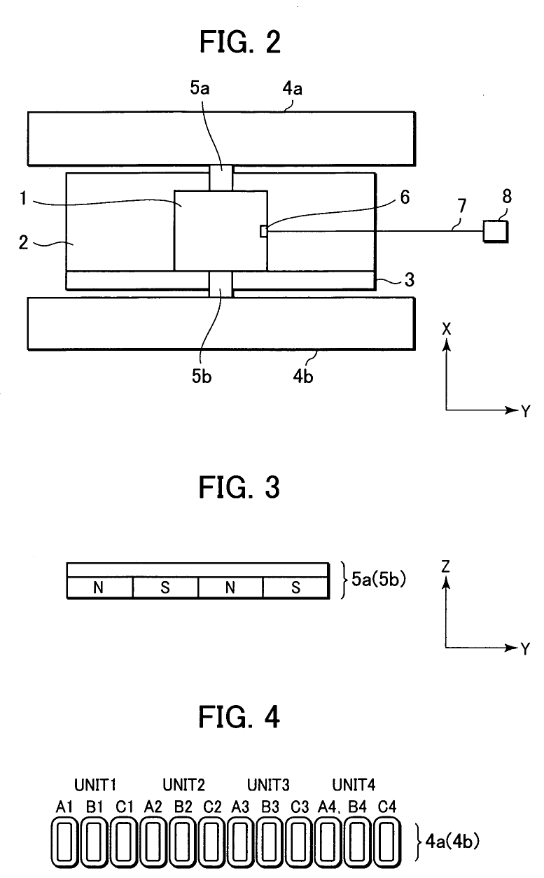

FIG. 1 is a block diagram of a stage control system according to a first embodiment. The details will be described later. FIG. 2 shows an example of a stage of a semiconductor exposure system using a polyphase linear motor as an actuator. A reticle, not shown, is placed on a stage 1. The stage 1 is movable only in one direction (Y direction) over a table 2 by means of a static-pressure guide, not shown, provided between the table 2 and a yaw guide 3. Stators 4a and 4b are placed on both sides of the table 2. Each of the stators is made up by arraying coil units, each having three phase coils in the Y direction. Movers 5a and 5b, consisting of magnets, are provided to the stage. The movers 5a, 5b and the stators 4a, 4b work together to produce a driving force to move the stage. As shown in FIG. 3, the magnets are arrayed with alternating N and S poles along the traveling direction of the mover pair. When the stage is to be driven in the Y direction, the same command is outputted to a pair of linear motors (4a, 4b, 5a, 5b) on both sides. A reflecting mirror 6 is provided in the stage 1 to reflect a measuring laser beam 7 from the outside of the stage 1 so that a laser interferometer 8 will measure the position (relative position) of the stage 1 in its traveling direction.

Returning to FIG. 1, inputted into the command selector 14 are a phase angle specifying command, a velocity control command, and a position control command. The three command inputs are selectively outputted according to the stage control operation. The velocity control command is generated by inputting to a controller (PID control system) 11 the value of velocity deviation corresponding to the difference between the velocity command (velocity targeted value) to the stage and stage velocity information calculated by a velocity calculator 13 using the time derivative of position information measured by the laser interferometer. The position control command is generated in a like manner by inputting to a controller (PID control system) 12 the value of position deviation corresponding to the difference between the position command (position targeted value) to the stage and stage position information. A command selected by the command selector 14 is outputted as an analog voltage and inputted into a current driver 15. The output voltage of the current driver 15 is controlled so that the current passing through a load connected to the output of the current driver 15 will be a value proportional to the commanded analog voltage. Thus, the current proportional to the signal outputted from the command selector 14 flows through the coils connected to the current driver. The current driver 15 is a three-phase system provided for A phase, B phase, and C phase.

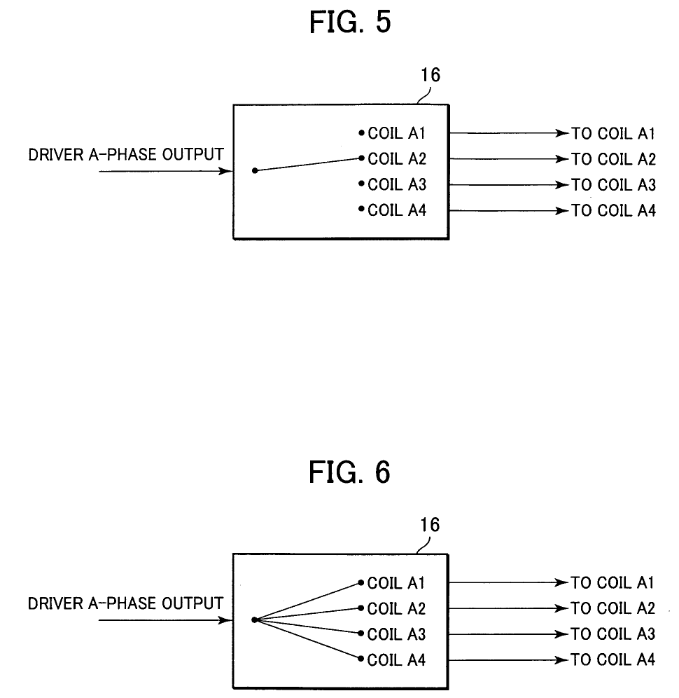

The following describes the operation of a coil selector 16. It is assumed here that four coil units are provided as shown in FIG. 4. The number of units may be designed according to the travel range of the stage. As shown in FIG. 5, the coil selector 16 selects one coil according to the relative position between the mover and the stator. FIG. 5 shows an example in which coil A2 is selected. The coil selector also selects B or C phase in a like manner. The position information on the stage 1 is undefined at power-on or reset of the laser interferometer due to an error. Since the laser interferometer is a relative position sensor, the value of the laser interferometer needs to be set when the stage 1 is at a specific position. At the time of this initialization, the coil selector 16 selects all the coils as shown in FIG. 6. In other words, the coils of all the units are connected in parallel relative to the current driver. The difference in resistance between coils is suppressed so that the same current can flow through all the coils even if they are connected in parallel in this manner.

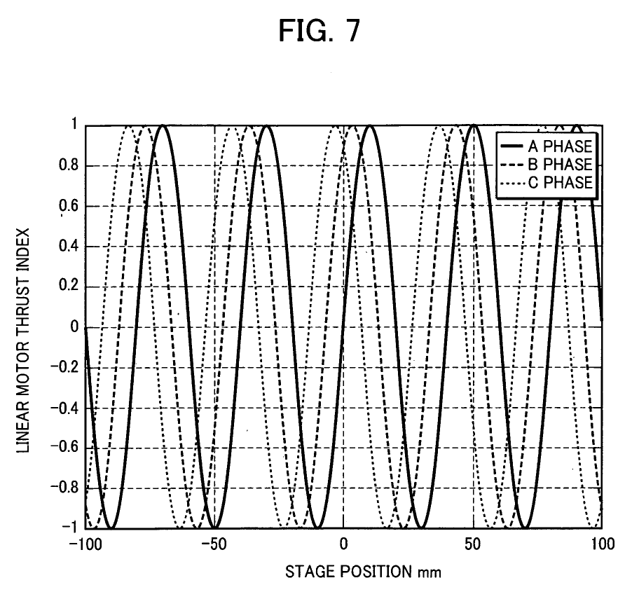

The whole function of the stage control system upon initialization will next be described. The command selector 14 selects the phase angle specifying command for phase A. As mentioned above, the coil selector selects all the coils. FIG. 7 shows indexes of propulsive forces or thrusts of the linear motor with respect to the position of the stage when a constant current flows through each phase of the three-phase linear motor. Although each index of linear motor thrust is represented as a sine wave, it may be represented by any other periodic wave such as a trapezoidal wave containing harmonic components. The thrust is proportional to the coil current. Here, the maximum thrust is normalized to 1. As shown in FIG. 7, the thrust indexes of respective phases are represented as sine waves 120 degrees out of phase with respect to each other. Therefore, if a current determined by multiplying a command current by a rectified value for the same phase as that of a corresponding sine wave is passed through each phase, the linear motor can produces constant thrust regardless of the position of the stage.

For example, if the cycle is 40 and the position of the stage is represented by x, each of the thrust indexes fa, fb, and fc for A, B, and C phases is determined as follows:
fa=sin(2*pi/40*x),
fb=sin(2*pi/40*x+π/3), and
fc=sin(2*pi/40*x+2*π/3).
Then suppose that each of the following currents is passed through each phase in response to a linear motor command i:
ia=i sin(2*pi/40*x),
ib=i sin(2*pi/40*x+π/3), and
ic=i sin(2*pi/40*x+2*π/3).
where each current is determined by multiplying the linear motor command i by the same rectified value calculated from trigonometric function in the above equations for the thrust indexes. In this case, the force F produced by the linear motor is determined as follows:
F=i*sin \hat{ }2(2*pi/40*x)+i*sin \hat{ }2(2*pi/40*x+π/3)+i*sin \hat{ }2(2*pi/40*x+2*π/3)=1.5*i.
From the result, it is found that the thrust calculated by multiplying the linear motor command i by a gain of 1.5 is produced regardless of the stage position x. If the thrust indexes fa, fb, and fc are deviated from the corresponding sine waves, slight thrust variations with respect to the position occur in the force F. The thrust variations are too small to be significant, because the command to the linear motor is outputted from the PID control system to which the difference between the measured value of the stage position and the command value is negatively fed back. However, the stage position cannot be specified upon initialization. This makes it impossible to estimate the phase angle and calculate the rectified value.

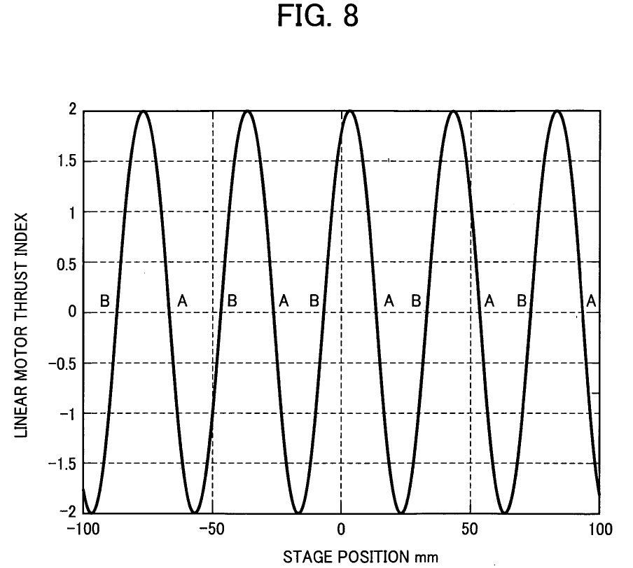

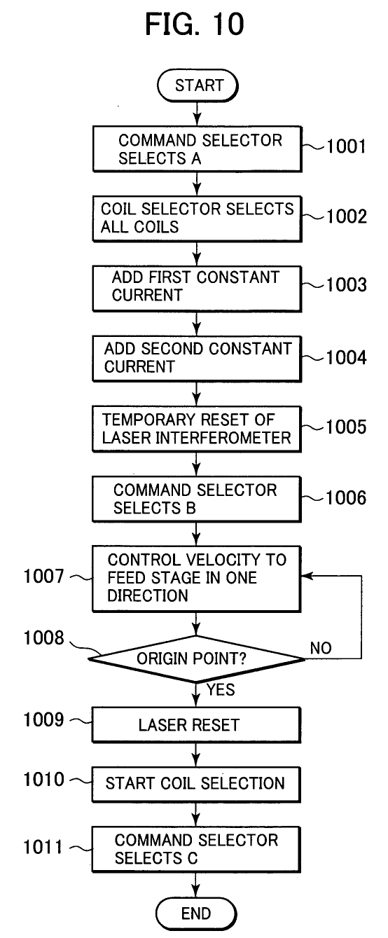

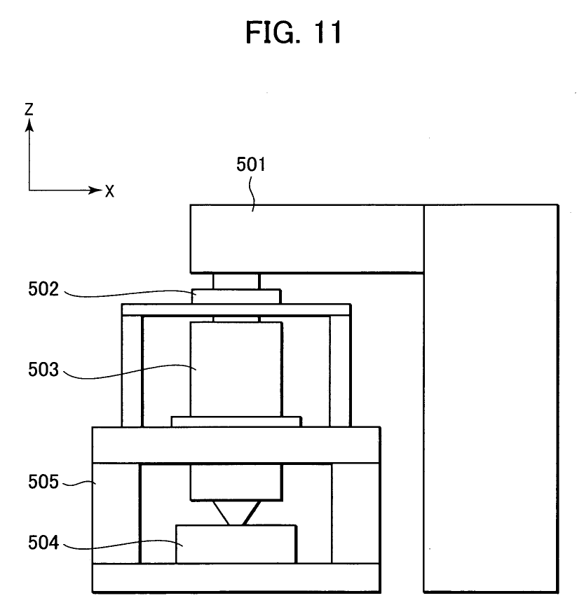

FIG. 10 is a flowchart of the initialization operation. As the first step of the initialization operation, the phase angle specifying command is inputted so that the same positive command value will be outputted as the first constant current to all the phases A, B, and C (1001 to 1003). FIG. 8 shows the thrust index of the linear motor with respect to the stage position in this case. The normalized value is 1 in FIG. 7, whereas the maximum value is normalized to 2 in FIG. 8. Suppose here that the stage is located around 0 mm as its initial position. The linear motor generates a positive force from the thrust index of FIG. 8 to move the stage in the positive direction. Then, once the thrust index curve exceeds point A (first electromechanical stability point) around 13.333 mm on the abscissa, the linear motor generates a negative force to move the stage in the negative direction. In other words, the stage exhibits spring-like behavior near the point A. In practice, the stage stops at a position, in close proximity to the point A, where the thrust is proportional to resistance forces, such as guide friction in the traveling direction of the stage and disturbance force from the lines to the stage. The force of the linear motor is zero at point B. Likewise, there is a dead zone near the point B (first electromechanical stability point), where the stage is stationary. As a result, the stage stops in close proximity to either the point A or the point B. The position relationship between the point A and the point B is plotted at regular intervals as shown in FIG. 8. The point at which the downward-sloping curve of the thrust index crosses zero is A, while the point at which the upward-sloping curve crosses zero is B.

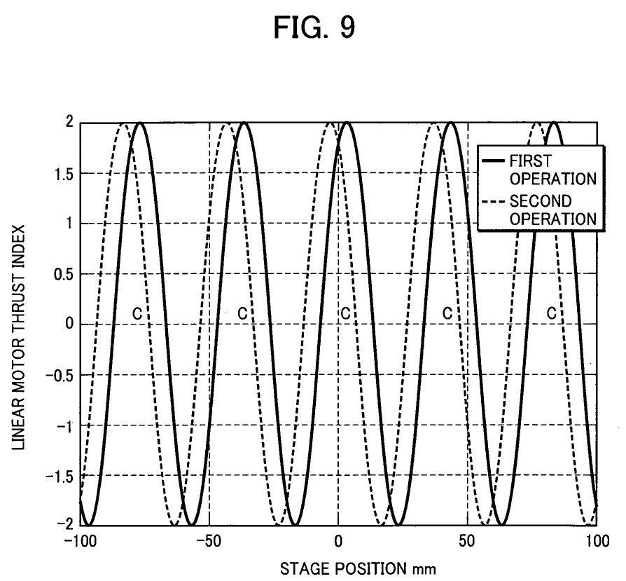

As the second step, a command to reverse the polarity of only the phase A specified by the command in the first step is outputted as the second constant current from means for generating a phase angle specifying command (1004). The thrust index of the linear motor at this time is shown as a dotted curve in FIG. 9. In FIG. 9, the solid curve represents the thrust index of the first step. In the second step, when the stage is located in close proximity to the point A, the linear motor thrust moves the stage in the negative direction, while when it is located in close proximity to the point B, the linear motor thrust moves the stage in the positive direction. In other words, the stage stops at a position in close proximity to point C (second electromechanical stability point) between the points A and B in FIG. 9 regardless of at which point it is located. The continuous operation of the first and second steps allows the stage to stop in close proximity to the point C in FIG. 9 regardless of the initial position of the stage. In FIG. 9, the point C is a point at which the downward-sloping curve of the thrust index crosses zero.

Upon completion of the second step, the laser interferometer is temporarily reset (1005). The phase of the force of the second step is equivalent to that of the C phase when the laser interferometer is finally reset to zero. Therefore, the laser interferometer is temporarily reset so that the measured value of the stage position will be the value of a position representative of the point C, for example, 6.666 mm. The coil selector 16 is set to select all the coils. Under this state, if the rectified value for each phase is calculated in the same manner as in the normal driving state, thrust roughly proportional to the driver current command can be generated regardless of the position of the stage. Specifically, a sine wave current that sets the electrical phase angle of a sine wave for each coil phase at the point C as its initial phase is supplied to each coil phase, thereby giving constant thrust regardless of the position of the stage.

Next, the command selector is switched to B to receive the velocity control command (1006). The velocity command is generated so that the stage is moved to a position where an origin point sensor, not shown, is located (1007 to 1008). A photo switch or the like is used as the origin point sensor. As mentioned above, the linear motor can generate thrust roughly proportional to the driver current command. Therefore, if a current command generated by the controller from the velocity deviation that is the difference between the stage velocity information calculated from the stage position information and the velocity command is outputted to the driver, the stage 1 can move at the speed specified in the velocity command. When the stage 1 reaches the position where the origin point sensor is located, the velocity command is set to zero for the final reset of the laser interferometer (1009). Then the stage position information is accurately determined as an absolute value. After that, the command selector 14 is switched to C to receive the position control command so that the coil selector 16 will start selecting coils based on the position information (1010 to 1011). Specifically, the position command is sent to the controller 12 to control the position of the stage. The initialization is completed by this operation.

The combination of current commands in the first and second steps is not limited to that mentioned above. Any other combination may be adopted as long as the stage can stop and stand still at a specific phase-angle position (second electromechanical stability point) through a two-step operation. In the embodiment, although the commands are issued to all the coils of A, B, and C phases, they may be issued to one phase at each step, such as by sending a command to A phase alone at the first step and a command to B phase alone at the second step. If different coil phases are selected in the first and second steps, the first constant current and the second constant current may be of the same value. In this case, the phase of the thrust index in the first step has only to be made different from that in the second step. However, considering the heat load on one coil and the load on the driver passing current through one phase, it is preferable that all the phases be used to produce a larger force. Further, as in the embodiment, it is preferable that the first constant current be of the same sign, plus or minus, for all phases in the first step and that the second constant current for one or more phases be of a sign opposite to the others in the second step to simplify the operation.

Considering a disturbance force exerted on the stage, the thrust force produced by the linear motor in the first and second steps must be larger than the disturbance force. For example, there is an iron-core linear motor as a kind of linear motor, in which a coil is wound around a comb-teeth-like metal yoke. In this case, the attractive force between the iron core and the magnet produces a cogging force that acts as a disturbance according to the stage position. The magnitude of the cogging force varies periodically as a function of the position of the stage so that the stage exhibits spring-like behavior to become stable and stop around positions where the cogging force is low. It is therefore necessary to give the first and second constant currents of adequate magnitude and sign in accordance with the phase angle specifying command to overcome the spring-like behavior.

In the embodiment, the moving magnet linear motor is used, but the present invention can also be implemented in the same manner in a moving coil linear motor.

Further, the embodiment shows an example in which the stage with a reticle on it moves in one direction. However, the present invention is not limited to the embodiment, and it is applicable to a stage with a wafer on it. The following illustrates an example in which the stage of the embodiment is applied to an exposure system in the lithography process.

FIG. 11 shows an exposure system for manufacturing semiconductor devices using the above stage device as a wafer or reticle stage.

This exposure system is used to manufacture devices each having a fine pattern on it, such as semiconductor devices like semiconductor integrated circuits, micro-machines, and thin-film magnetic heads. In operation, exposure light as exposure energy is emitted from an illumination unit 501, and passed through a projection lens system 503. Then it is projected onto a semiconductor wafer as a substrate through a reticle having a master pattern on it, thereby forming a desired pattern on the substrate placed on a wafer stage 504. Here, the exposure light is the generic name for all light used in the exposure system, and includes visible light, ultraviolet light, EUV light, X-ray, electron beam and charged particle beam. The projection lens system is the generic name for all lenses used in the exposure system, and includes a refractor, reflector lens, catadioptric system and charged-particle lens. As the wavelength of the exposure light gets shorter, this type of exposure system needs to perform exposure in a vacuum environment.

In this case, the reticle pattern as the master pattern is transferred to each region on the wafer by means of the illumination unit 501 by a step-and-repeat or a step-and-scan method while holding the wafer (target) as the substrate on a chuck placed on the wafer stage 504. The stage device of the first embodiment is used as the wafer stage 504 or a reticle stage 502.

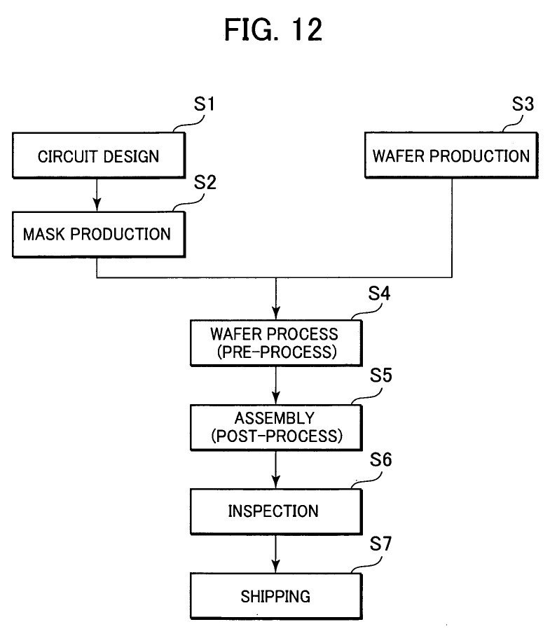

The following describes the manufacturing process of semiconductor devices using the exposure system. FIG. 12 is a flowchart showing the flow of the entire manufacture process of semiconductor devices. In step S1 (Circuit Design), the circuitry of a semiconductor device is designed. In step S2 (Mask Production), a mask is produced based on the circuit pattern design.

On the other hand, in step S3 (Wafer Production), wafers are produced using a material(s) such as silicon. In step S4 (Wafer Process), also called pre-process, the mask and wafers are used in the above-mentioned exposure system to form actual circuit patterns on the wafers using lithography. Next, in step S5 (Assembly), also called post-process, a semiconductor chip is fabricated using each of the wafers produced in step S4. This step includes the assembly process (dicing and bonding) and the packaging process (chip packaging). In step S6 (Inspection), various tests on the semiconductor devices fabricated in step S5 are performed such as operation and durability tests. After going through these steps, the semiconductor devices are shipped in step S7.

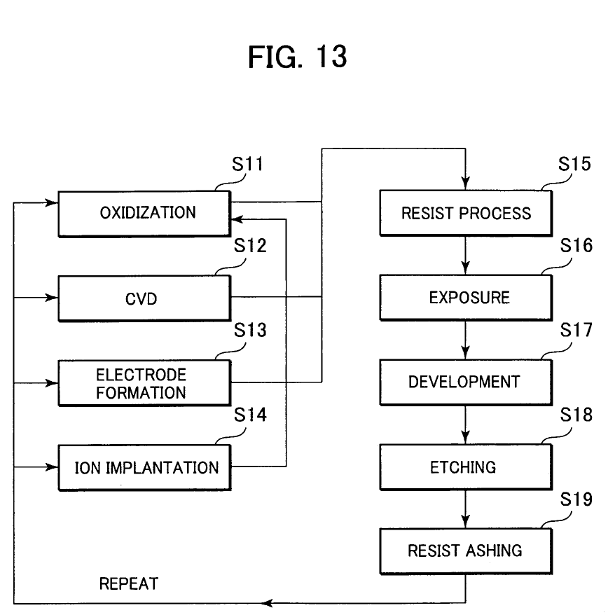

The wafer process in step S4 includes the following processes (FIG. 13):
an oxidization process S11 for oxidating the surface of the wafer;
a CVD process S12 for forming a dielectric film on the wafer surface;
an electrode forming process S13 for forming electrodes on the wafer by an evaporation technique;
an ion implantation process S14 for implanting ion into determined regions of the wafer;
a resist process S15 for coating the wafer with a photosensitive material or photoresist;
an exposure process S16 for transferring the circuit pattern onto the photoresist coated wafer using the exposure system;
a development process S17 for developing the wafer exposed in the exposure process;
an etch process S18 for striping the dielectric film in accordance with the pattern developed on the wafer; and
a resist ashing process S19 for removing the resist after the etch process.

These processes are repeated to form multiple circuit patterns on the wafer.

While the present invention has been described with respect to what is presently considered to be the preferred embodiments, it is to be understood that the invention is not limited to the disclosed embodiments. The present invention is intended to cover various modifications and equivalent arrangements included within the spirit and scope of the appended claims.

This application claims priority from Japanese Patent Application No. 2004-008120 filed Jan. 15, 2004, which is hereby incorporated by reference herein.

1. A drive method of a polyphase linear motor having a mover and a stator, comprising:
a first step of supplying a first constant current to at least one of the phases of a plurality of coils to drive the mover to a first electromechanical stability point;
a second step of supplying a second constant,current to drive the mover to a second electromechanical stability point; and
a third step of supplying a predetermined current to each coil phase according to the second electromechanical stability point to drive the mover to a predetermined reference position.

2. The method according to claim 1, wherein
at least two first electromechanical stability points are provided so that the second electromechanical stability point will be located between the first electromechanical stability points.

3. The method according to claim 1, wherein
the phase of a sum of thrusts produced by respective coil phases under the application of the second constant current is different from a phase of the sum of thrusts produced by respective coil phases under the application of the first constant current.

4. The method according to claim 1, wherein
at least one of a positive and a negative constant current is supplied in said first step to all the phases of the plurality of coils, and a constant current with a sign opposite to that supplied in said first step is supplied in said second step to at least one of all the coil phases.

5. The method according to claim 1, wherein
the polyphase linear motor includes a plurality of coil units each having the plurality of coil phases so that a current passes through all the coil units in said first and second steps.

6. The method according to claim 1, wherein
one of the mover and the stator has a magnet part that produces a periodic distribution of magnetic flux along the traveling direction of the mover.

7. The method according to claim 1, wherein
the polyphase linear motor includes relative position detecting means for detecting the relative position of the mover and reference position determining means for determining the reference position of the mover, and
said method further comprises a fourth step of detecting an absolute position of the mover using the relative position detecting means based on the reference position determined by the reference position determining means.

8. The method according to claim 1, wherein
the predetermined current supplied in said third step is a current that exhibits periodicity having as its initial phase the electric phase angle of each coil phase at the second electromechanical stability point.

9. A stage device comprising means for performing initialization using a drive method according to claim 1 to locate the position of a moving stage fixed to the mover.

10. An exposure system comprising a stage device according to claim 9 and means for exposing a substrate or master mask placed on the moving stage.

11. A device manufacturing method in which a polyphase linear motor having a mover and a stator is used for manufacturing devices, comprising the steps of:
supplying a first constant current to at least one of the phases of a plurality of coils to drive the mover to a first electromechanical stability point;
supplying a second constant current to drive the mover to a second electromechanical stability point;
supplying a predetermined current to each coil phase according to the second electromechanical stability point to drive the mover to a predetermined reference position;
locating the position of a moving stage fixed to the mover; and
exposing a substrate or master mask placed on the moving stage.

12. A polyphase linear motor having a mover and a stator, comprising:
phase angle specifying command generating means for generating a command for specifying the phase angle determined from the relative position between the mover and the stator; and
a driver for selecting at least one of a plurality of coils based on the command from said phase angle specifying command generating means to supply the selected coil(s) with a first constant current and then to supply a second constant current to the same or different coil(s) as or from those selected for supplying the first constant current.

13. The polyphase linear motor according to claim 12, wherein
the phase of a sum of thrusts produced by respective coil phases under the application of the second constant current is different from a phase of the sum of thrusts produced by respective coil phases under the application of the first constant current.

14. A stage device for comprising a polyphase linear motor according to claim 12 for locating the position of a moving stage fixed to the mover.

15. An exposure system comprising a stage device according to claim 14, and means for exposing a substrate or master mask placed on the moving stage.

16. A device manufacturing method in which a polyphase linear motor having a mover and a stator is used for manufacturing devices, comprising the steps of:
supplying a first constant current to at least one of the phases of a plurality of coils to drive the mover to a first electromechanical stability point;
supplying a second constant current to drive the mover to a second electromechanical stability point;
supplying a predetermined current to each coil phase according to the second electromechanical stability point to drive the mover to a predetermined reference position;
locating the position of a moving stage fixed to the mover; and
exposing a substrate or master mask placed on the moving stage.

17. A drive method of a polyphase linear motor having a mover and a stator and having a periodic thrust index, the polyphase linear motor including a plurality of coil units each having a plurality of coil phases, comprising
supplying a first constant current to all the plurality of coil units; and
supplying a second constant current different from the first constant current to specify the phase angle determined from the relative position between the mover and the stator.

18. The method according to claim 17, wherein
the second constant current is made different from the first constant current by changing a combination of current values to be supplied to each coil phase of the coil units.

19. A stage device comprising means for performing initialization using said drive method according to claim 17 to locate the position of a moving stage fixed to the mover.

20. An exposure system comprising a stage device according to claim 19 and means for exposing a substrate or master mask placed on the moving stage.

21. A device manufacturing method for manufacturing devices, the method utilizing a polyphase linear motor having a mover and a stator, having a periodic thrust index, and including a plurality of coil units each having a plurality of coil phases, comprising:
supplying a first constant current to all the plurality of coil units; and
supplying a second constant current different from the first constant current to specify the phase angle determined from the relative position between the mover and the stator;
locating the position of a moving stage fixed to the mover; and
exposing a substrate or master mask placed on the moving stage.
